(19) United States
(12) Patent Application Publication
(10) Pub. No.: US 2008/0301771 A1
(43) Pub. Date: Dec. 4, 2008

(54) ELECTRONIC DEVICE, APPLICATION AUTHENTICATION METHOD, APPLICATION EXECUTION SYSTEM, AND COMPUTER READABLE MEDIUM CONTAINING EXECUTABLE PROGRAM INSTRUCTION

(76) Inventors: Takanao Kawai, Osaka (JP); Sachiko Yoshimura, Osaka (JP)

Correspondence Address: FROMMER LAWRENCE & HAUG, 745 FIFTH AVENUE- 10TH FL., NEW YORK, NY, 10151, US

(21) Appl. No.: 12/131,567

(22) Filed: Jun. 2, 2008

(30) Foreign Application Priority Data
Jun. 4, 2007 (JP) 2007-147848

(51) Int. Cl. G06F 21/00

(52) U.S. Cl. 726/2

(57) ABSTRACT

The present invention claims and discloses an electronic device comprising a storage part for storing a license check processing program for checking a license in order to execute a processing function of an application program, license setting information containing location information where the license check processing program is executed within the application program; and an application program execution part for executing the application program by associating the license check processing program with a location preset in the application program based on the license setting information stored in the storage part. The present invention further teaches performing a license check processing by the license check processing program associated with the location, and when the license is not properly authenticated, the program in accordance with the present invention will skip the processing function corresponding to the license check processing program to execute a subsequent processing function.

### INCORPORATION BY REFERENCE

This application is based upon and claims the benefit of priority from the corresponding Japanese Patent Application No. 2007-147848, filed Jun. 4, 2007, the entire contents of which is incorporated herein by reference.

### FIELD OF THE INVENTION

The present invention teaches and claims an electronic device, an application authentication method, an application execution system, and a computer readable medium containing executable program instructions. More particularly, the present invention discloses improvements in an electronic device, such as a multi-function peripheral (MFP) that can be connected to a network, an application authentication method, an application execution system, and the computer readable medium containing executable program instructions that are preferably used for the electronic device claimed and disclosed.

### BACKGROUND OF THE INVENTION

In recent years, multi-function peripherals and similar electronic devices have been providing various functions that are in accordance with the operations of an application program. Additionally, from the standpoint of providing security and limiting functions for an application program on a user basis, authentication is used to impose various limitations on processing functions of the application program.

An application program customarily determines which application program interface (API) is available thereto based on license information of the application program. However, such limitation is placed on an available application program interface (API) arbitrarily for each application program to allow imposition of a limitation on each application program in terms of its available function. More often than not, applications held in a center server are executed from a user terminal by user authentication. This allows the center server to execute the application without installation of the application on the user terminal.

### SUMMARY OF THE INVENTION

The present invention remedies the disadvantages and shortcomings of the background art by providing an electronic device, an application authentication method, an application execution system, and a computer readable medium containing executable program instructions. The units in accordance with the present invention impose functional limitation based on license authentication and the functional limitation can be flexibly set for an installed application program in order to improve their usability.

An electronic device according to one aspect of the present invention comprises an electronic device storage part that stores a license check processing program, a license setting information; and an application program execution part that executes an application program and determines whether or not a license authenticated.

Further, an application authentication method according to one embodiment of the present invention comprises the steps of: storing license authentication information for authenticating a license with respect to an application program, providing a license check processing program and license setting information; receiving a license ID; verifying whether the license ID received is authenticated based on the license authentication information; and transmitting the license check processing program and the license setting information when the received license ID is authenticated.

Further, an application execution system according to another aspect of the present invention is configured such that an electronic device that executes an application program and a server that performs license authentication with respect to the application program are connected via a network.

Still according to a further aspect of the present invention, the electronic device includes an electronic device communication part that transmits a license ID for authenticating a license with respect to the application program to the server via a network. The electronic device communication part also receives from the server a license check processing program. The license check processing program checks a license to execute a processing function of the application program and license setting information. Also included in the electronic device is an electronic device storage part that stores the license check processing program and the license setting information. An application program execution part is part of the electronic device. The application program execution part executes the application program.

Still a further aspect of the present invention provides a server that includes a server storage part that stores license authentication information, the license check processing program, and the license setting information. The server further includes a server communication part that receives the license ID from the electronic device via the network, and transmits the license check processing program and the license setting information to the electronic device. A license check part of the server performs transmission control of the license check processing program and the license setting information that correspond to the license ID after authenticating a received license ID based on the license authentication information.

According to yet another further aspect of the invention, the present invention comprises a computer readable medium containing executable program instructions that, when executed by a computer, causes the computer of an electronic device to implement a method for executing an application program. The method includes storing a license check processing program and license setting information, executing the application program by associating the license check processing program with a preset location in the application program; and performing a license authentication check by the license check processing program associated with the preset location.

The above and other objects, features, and advantages of the present invention will be more apparent from the following detailed description taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a block diagram illustrating an application execution system including an electronic device according to one embodiment of the present invention;

FIG. 2 is an explanatory diagram of an outline of an application program according to another embodiment of the present invention;

FIGS. 3A and 3B are explanatory diagrams of license setting information according to an embodiment of the present invention;

FIG. 4 is a flowchart for explaining an operation of the electronic device according to yet another embodiment of the present invention;

FIG. 5 is a flowchart for explaining an operation of a server according to still yet another embodiment of the present invention; and

FIG. 6 is a flowchart for explaining the operation the electronic device according to a further embodiment of the present invention.

### DETAILED DESCRIPTION OF THE PREFERRED EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combination, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations come within the scope of the appended claims and their equivalents.

Hereinafter, description will be made of various embodiments of the present invention with reference to the accompanying drawings. Note that an electronic device, an application authentication method, and a computer readable medium containing executable program instructions according to embodiments of the present invention will be described by explaining and referencing an application execution system according to one embodiment of the present invention.

The computer readable medium (for example a ROM, a hard disk, a flexible disk, a memory card, or an optical disk) in accordance with the embodiment of the present invention stores an application execution program that is configured by program instructions for executing an application program.

The electronic device next loads the application execution program from the computer readable medium so that the application execution program allows the respective components in the electronic device to execute any required processes.

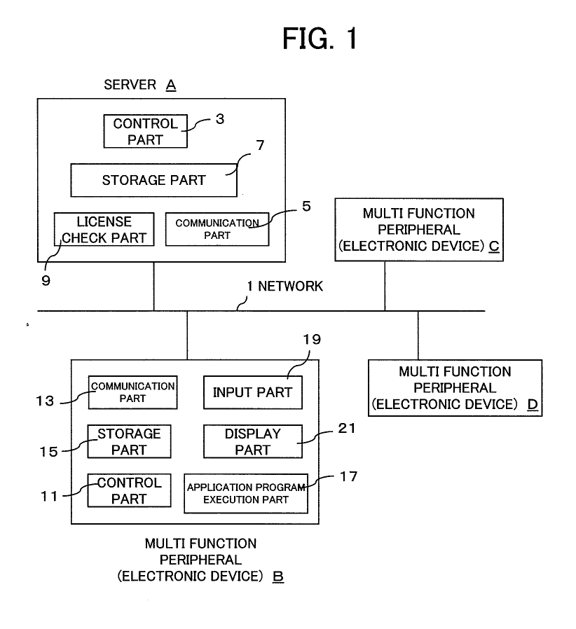

FIG. 1 is a block diagram illustrating the application execution system according to one embodiment of the present invention, in which server A is connected with electronic device, for example, multi-function peripherals B, C and D via network 1. The server A will be described first.

In FIG. 1, server A is configured to include a control part 3 serving as a main component, a communication part 5, a storage part 7, a license check part 9, and other similar components. Server A has various functions including, but not limited to, a license server function to provide authentication results in response to an authentication request of an application program from each of the multi-function peripherals B, C and D that executes the application program installed.

The application program executes on the electronic device in which the program is installed. Examples of application programs installed in the multi-function peripherals B, C and D may include, but are not limited to, programs for executing a document read/copy function, print function, a facsimile transmission/reception function, a network data transmission/reception function, and other similar functions.

The communication part 5 has functions controlled by the control part 3 to receive license IDs and passwords, which will be described in detail in subsequent paragraphs. The license IDs and passwords are transmitted from the multi-function peripherals B, C or D via network 1 according to a predetermined communication protocol. The communication part 5 outputs the license IDs and passwords to the license check part 9. The communication part 5 also has functions controlled by the control part 3 to transmit a license check processing program and license setting information, which will be described later. The license check processing program and license setting information are typically sent from the license check part 9 to the multi-function peripherals B, C or D. The communication part 5 serves as transmission sources of the license IDs and the like.

The storage part 7 is a component that could be a hard disk drive or the like having a function controlled by the control part 3 to readably/writably store an operating program of the control part 3 and the like in addition to license authentication information used for license authentication with respect to the application program, the license check processing program, and the license setting information.

The license authentication information represents an aggregate of information items used for performing license authentication with respect to each of the provided or sold individual application programs. The information items include, for example, a license ID for identification assigned to each of the application programs and a password that have been previously supplied by application program makers.

The license check processing program is provided for each application program and is used to check and confirm whether or not a license is authenticated at a preset location (program step). This license check processing program can also check the license used to execute a processing function of the application program, for example, a function having a limitation on the number of copies, the number of facsimile transmissions, the expiration date of use, or the like, and is formed of a plurality of program modules previously supplied by the same maker who also provided the application program.

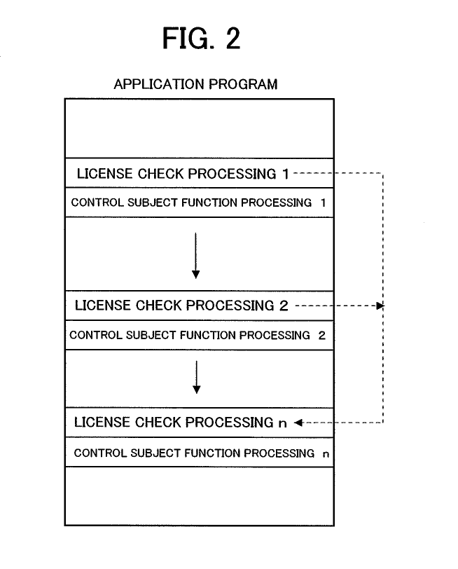

Upon creation of the program, for example, as shown in FIG. 2, the license check processing program is embedded at preset locations of license check processings 1, 2, . . . , and n in each application program for later execution.

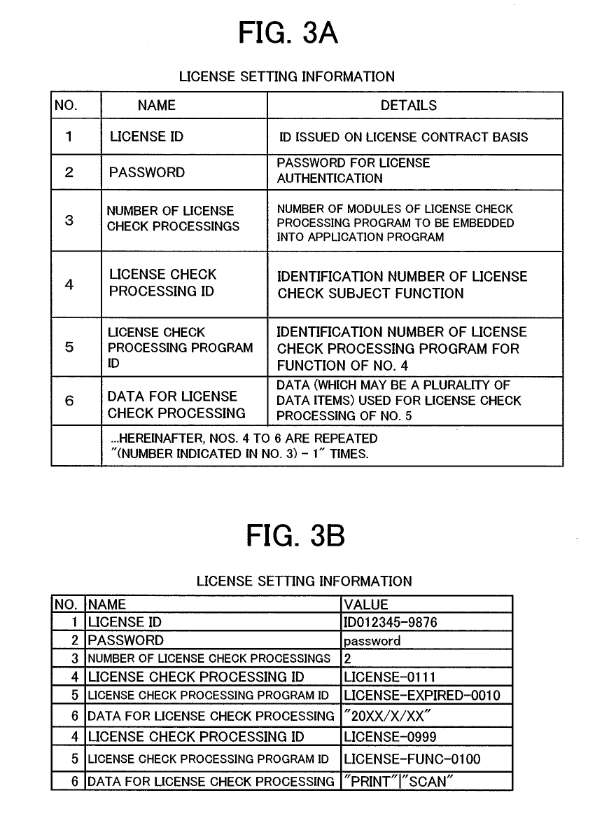

The above-mentioned license setting information has setting information as shown in FIGS. 3A and 3B in addition to location information (location information indicating the locations of the license check processings 1, 2, . . . , and n) at which the license check processing program is executed for the application program.

More particularly, in FIG. 3A, the license setting information includes information items for each application program such as a “license ID” indicating an ID issued on a license contract basis, a “password” used for a license authentication request, a “number of license check processings” indicating the number of modules of the license check processing program to be embedded into the application program, a “license check processing ID” indicating the identification number of a license check subject function, a “license check processing program ID” indicating the identification number of a program that checks the license to perform the license check subject function, and “data for license check processing” indicating data used for a license check processing. The license setting information is prestored in the storage part 7 in FIG. 1.

The license setting information is set as shown in FIG. 3B, for example, and has Nos. 4 to 6 repeated a predetermined number of times (once in this example). The predetermined number is obtained by subtracting 1 from the number of processings indicated in No. 3 entitled “number of license check processings”.

The license check part 9 has functions controlled by the control part 3 to check whether or not the received license ID is authenticated based on the license authentication information stored in the storage part 7. It also has functions controlled by control part 3 to read out when the license ID is authenticated due to the existence of a license ID corresponding to the received license ID, a license check processing program and license setting information that correspond to the license ID from the storage part 7 and control transmission thereof performed from the communication part 5 to one of the multi-function peripherals B, C and D that has transmitted the license ID.

The control part 3 includes a CPU and a ROM storing an operating program for the CPU. The control part 3 has functions to control the communication part 5, the storage part 7, the license check part 9, and other such components, and is responsible for part of the functions of those components.

Next, description will be made of structural components of the multi-function peripherals B, C and D serving as the electronic devices according to other embodiments of the present invention.

Note that the multi-function peripherals B, C and D have the same basic components. Therefore, the components of, for example, the multi-function peripheral B will be described with the description of the multi-function peripherals C and D being omitted.

The multi-function peripheral B is configured to include a control part 11 serving as a main component, a communication part 13, a storage part 15, an application program execution part 17, an input part 19, a display part 21, and other similar components, and executes installed application programs to execute, for example, the document read/copy function, print function, the facsimile transmission/reception function, the network data transmission/reception function, and other such functions as described above.

Note that the application programs are supplied by being inputted and installed from a component (not shown) of the multi-function peripheral B such as a CD-ROM drive or a USB memory input port, or by being prestored.

The communication part 13 has functions controlled by the control part 11 to transmit the license ID and the password of an application program. The license ID and the password are inputted from the input part 19, to the server A via the network 1 according to a predetermined communication protocol. The functions of the communication part 13 controlled by the control part 11 enable the communication part 13 to receive the above-mentioned license check processing program and license setting information from the server A after the license ID is authenticated. These functions also output the license check processing program and license setting information to the storage part 15.

The storage part 15 represents, for example, a hard disk drive that is controlled by the control part 11 to store an operating program of the control part 11 as well as readably/writably store the license check processing program and license setting information transmitted from the server A in addition to the installed application program.

The application program execution part 17 has a function to execute an application program by associating a license check processing program with a location preset in the application program. The association is based on the license setting information stored in the storage part.

The application program execution part 17 has another function to read out the license check processing program associated with the location from the storage part 15. The application program execution part 17 reads the license check processing program during execution of the application program to execute a license check processing. When the license check processing is performed without a problem owing to the confirmed license, the application program execution part 17 executes a processing function corresponding to the license check processing program. But when the license is not confirmed, it skips the processing function corresponding to the license check processing program to execute a processing function subsequent thereto.

For example, FIG. 2 provides that the license check processing 1 relates to a limitation on the copy (print) function. Thus when the license to perform the copy (print) function is not confirmed, a copy (print) processing function is not performed, and the procedure advances to the license check processing n subsequent thereto.

The input part 19 includes a touch switch and a keyboard provided to a device main body. The input part 19 includes functions controlled by the control part 11 to receive a license ID and a password in addition to application program supply source information and application program identification information by a user's input operation. Also the input part 19 has functions controlled by the control part 11 to transmit the license ID and the password from the communication part 13 to the server A to make an instruction for a license authentication request.

The display part 21 represents, for example, a liquid display part that is controlled by the control part 11. The display part 21 displays input information transmitted from the input part 19 and an operation condition of the multi-function peripheral B.

The control part 11 includes a CPU and a ROM storing an operating program for the CPU. The control part 11 has functions to control the communication part 13, the storage part 15, the application program execution part 17, the input part 19, the display part 21, and other such components, and is responsible for part of functions of those components.

Note that the multi-function peripheral B has other components, which are not directly relevant to the present invention, and therefore description thereof will be omitted.

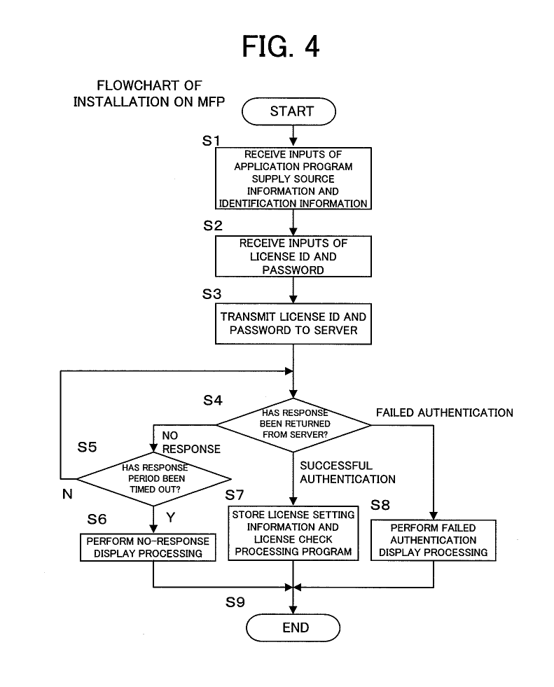

Next, the flowchart of FIG. 4 will be referenced to describe an operation of any one of the above-mentioned multi-function peripherals B, C and D.

In Step S1, the input part 19 receives inputs of application program supply source information and identification information. In Step S2, the input part 19 receives inputs of a license ID and a password. In Step S3, the control part 11 transmits the license ID and the password from the communication part 13 to the server A, and then advances to Step S4.

In Step S4, the control part 11 waits for a response from the server A. If there is no response returned from the server A within a predetermined time period, the control part 11 determines in Step S5 whether or not a response period is timed out. If the timeout has not occurred, with “NO” in Step S5, the procedure returns to Step S4 to repeat Steps S4 and S5. If the timeout has occurred, with “YES” in Step S5, the control part 11 performs a no-response display processing through the display part 21 in Step S6, and then terminates the procedure.

If a response of successful authentication is returned from the server A, in Step S7, the control part 11 stores a license check processing program and license setting information in the storage part 15, then terminates the procedure. If a response of failed authentication is returned from the server A, the control part 11 advances from Step S4 to Step S8 to display a failed authentication message through the display part 21, and then terminates the procedure.

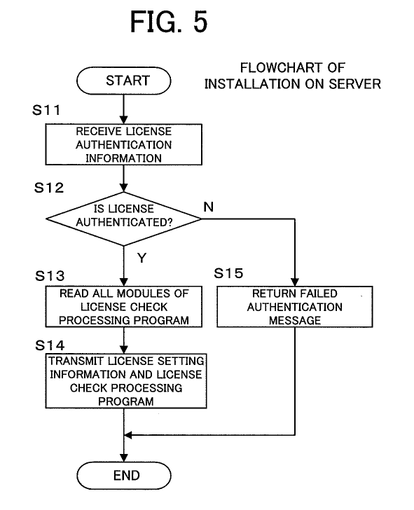

The above-mentioned operation of the server A will be further described with reference to the flowchart of FIG. 5.

In Step S11, the communication part 5 receives the license ID and the password. In Step S12, the license check part 9 confirms the license information. If it is confirmed that the license is authenticated with “YES” in Step S12, the license check part 9 advances to Step S13 to read all of the modules of the license check processing program and license setting information.

Subsequently, in Step S14, the license check part 9 transmits the license check processing program and license setting information to one of the multi-function peripherals B, C and D via the communication part 5, and then terminates the procedure.

If it is not confirmed that the license is authenticated with “NO” in Step S12, the license check part 9 advances to Step S15 to return the failed authentication message to one of the multi-function peripherals B, C and D through the communication part 5, and then terminates the procedure.

The processing procedure shown in FIG. 5 corresponds to the application authentication method for the server A.

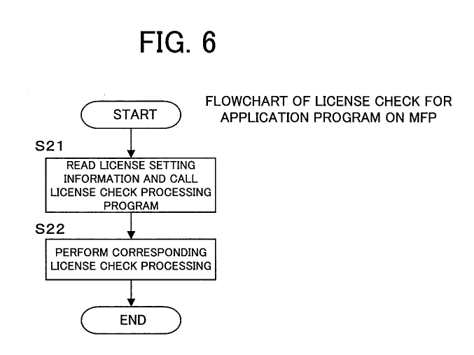

Further, the flowchart of FIG. 6 will be referenced to describe a license check processing operation upon execution of the application program on any one of the multi-function peripherals B, C and D according to the embodiment of the present invention.

In Step S21, the application program execution part 17 reads out license setting information and a license check processing program. In Step S22, the application program execution part 17 executes the license check processing program, and then terminates the procedure.

Those processes as shown in FIGS. 4 to 6 correspond to the application execution system according to the embodiment of the present invention. FIGS. 4 and 6 correspond to the computer readable medium containing executable program instructions according to the embodiment of the present invention.

The application execution system according to one embodiment of the present invention as described above has a structure in which the multi-function peripherals (electronic devices) B, C and D that each execute an application program. The multi-function peripherals each connect with the server A that performs license authentication with respect to the application program via the network 1.

In particular, those multi-function peripherals (electronic devices) B, C and D each include the communication part 13 for transmitting a license ID. The license ID is transmitted for license authentication with respect to an application program to the server A via the network 1. The communication part 13 for each multi-function peripheral also receives a license check processing program and license setting information from the server A. The multi-function peripherals also include storage part 15 for storing the license check processing program and license setting information. In addition the peripherals include the application program execution part 17 for executing an application program by associating the license check processing program with a location preset in the application program. This association is based on the license setting information stored in the storage part. When the license is not confirmed by the license check processing program, the processing function corresponding to the license check processing program is skipped to execute a processing function subsequent thereto.

Further, server A includes storage part 7 for prestoring the license authentication information. This information is used for license authentication with respect to the application program. The license check processing program checks a license to execute a processing function of the application program corresponding to the license authentication information. The license authentication information also includes the license setting information containing the location information at which the license check processing program is executed for the application program. The storage part 7 of server A further includes the communication part 5 for receiving the license ID from any one of the multi-function peripherals (electronic devices) B, C and D via the network 1. The communication part 5 also transmits the license check processing program and the license setting information to the one of the multi-function peripherals (electronic devices) B, C and D. Furthermore, the storage part 7 includes the license check part 9 for checking whether or not the received license ID is authenticated. The authentication is based on the license authentication information stored in the storage part. The license check part 9, performs, when the license ID is authenticated, transmission control of the license check processing program and license setting information that correspond to the license ID to the one of the multi-function peripherals (electronic devices) B, C and D.

Because the license check processing is thus performed by the license check processing program associated with the preset location in the application program during execution, the imposition of function limitations such as follows can easily be executed. The function limitations imposed are based on the license by setting the license setting information containing not only the use permissions such as a copy limitation, a facsimile transmission limitation, and a use limitation, but also the number of times, the expiration date for use, and the like such as a limitation on the number of copies, a limitation on the number of facsimile transmissions, and expiration date settings, and by providing the license check processing program for executing the imposition of function limitations. Accordingly, the imposition of function limitations can be executed based on the license with the units of function limitations being set finely and flexibly.

In addition, there is no need to create license authentication modules for each application program, thereby reducing the load on program management.

The same effects as the application execution system according to the embodiment of the present invention are also produced by the multi-function peripherals (electronic devices) B, C and D, the application authentication method, and the computer readable medium containing executable program instructions according to the embodiment of the present invention.

In a case where the license is updated, the application program supplier issues a new license based on the user's request, and the license authentication information stored in the server A is updated or new license authentication information is added.

Meanwhile, the users of the multi-function peripherals (electronic devices) B, C or D merely need to input a new license ID and password, and the same processing as that performed upon installation occurs on the multi-function peripherals (electronic devices) B, C or D.

In the present invention, the license setting information does not necessarily need to include the above-mentioned various setting items. The license setting information may include the location information at which the license check processing program is incorporated into the application program to be installed. If the license setting information is set based on necessary license authentication items, the object of the present invention can be achieved.

Note that the above-mentioned multi-function peripherals B, C and D are each configured to request license authentication to the server A to obtain the license setting information and the license check processing program and execute the license check processing, but the multi-function peripherals B, C and D may be configured without using the server A.

For example, the application program installed in each of the multi-function peripherals B to D may be configured to include license setting information and a license check processing program that are expected to be used.

The supply maker may add all of the license check processing programs to all of the application programs to be supplied, and supply users with only the license setting information rewritten according to a license contract on a user basis.

However, the authentication processing upon installation needs to be executed by the application program to be installed. Therefore, the imposition of function limitations can be executed more multi-functionally and more finely with the multi-function peripherals B, C and D as described above with reference to FIG. 1. Each of the multi-function peripherals B, C, and D include the communication part 13 connected to a network, transmit a request for license authentication from the communication part 13 to the server A via the network 1, and use the license check processing program and license setting information that are returned when the license is authenticated.

Note that the present invention can be widely implemented in not only the multi-function peripherals but also various electronic devices that are operated by installed application programs.

From the above embodiment, the present invention is summarized as follows.

An electronic device according to an aspect of the present invention includes: an electronic device storage part that stores a license check processing program, a license setting information; and an application program execution part that executes an application program and determines whether or not a license authenticated.

In the electronic device, the license check processing program determines whether a license is authenticated. The application program skips the processing function corresponding to the license check processing program to execute a subsequent processing function when the license is not authenticated. The license setting information includes at least one location information where the license check processing program is executed within the application program. The application program execution part executes the application program by associating the license check processing program with a preset location in the application program based on the licensed setting information.

The electronic device may be configured to include an electronic device communication part connected to a network, and to input the license check processing program and the license setting information that are stored in the storage part via the communication part.

The electronic device may be configured such that the license check processing program and the license setting information are transmitted, after a license is authenticated, in response to a request for license authentication made from the communication part to a server connected to the network.

Further, an application authentication method according to another aspect of the present invention includes the steps of: storing license authentication information for authenticating a license with respect to an application program, providing a license check processing program and license setting information; receiving a license ID; verifying whether the license ID received is authenticated based on the license authentication information; and transmitting the license check processing program and the license setting information when the received license ID is authenticated.

Further, an application execution system according to another aspect of the present invention is configured such that an electronic device for executing an application program and a server connected to the electronic device via a network for performing license authentication with respect to the application program.

Still further, the electronic device includes: an electronic device communication part that transmits a license ID for authenticating a license with respect to the application program to the server via a network, and receives from the server a license check processing program for checking a license and executing a processing function of the application program and license setting information; an electronic device storage part that stores the license check processing program and the license setting information; and an application program execution part that executes the application program.

In the electronic device of the application execution system, the license ID is transmitted for licensed authentication with respect to the application program. The license checking program is received for authenticating a license in order to execute a processing function of the application program. The license setting information contains location information where the license check processing program is incorporated into the application program.

Still further, the server includes: a server storage part that stores license authentication information; the license check processing program; and the license setting information, a server communication part that receives the license ID from the electronic device via the network and transmits the license check processing program and the license setting information to the electronic device; and a license check part that performs transmission control of the license check processing program and the license setting information that correspond to the license ID after authenticating a received license ID based on the license authentication information.

In the application execution system, the application program execution part executes the application program by associating a license check processing program with a preset location in the application program based on the licensed setting information stored in the electronic device storage part. The application execution part performs a license authentication check with the license check processing program associated with the preset location in the application program. When the license is not authenticated, the application execution part skips the processing function corresponding to the license check processing program to a subsequent processing function.

Yet further, according to another aspect of the present invention, there is a computer readable medium containing executable program instructions, that when executed by a computer, causes the computer of an electronic device to implement a method for executing an application program. The method includes the steps of: storing a license check processing program and license setting information, executing the application program by associating the license check processing program with a preset location in the application program, performing a license authentication check the license check processing program associated with the preset location.

In the method, the license check processing program checks a license to execute a function of the application program. The license setting information contains location information where the license check processing program is incorporated into the application program. The license checking program is associated with a preset location in the application program based on the licensed setting information. When the license is not authenticated, the license authenticating step skips the license check processing function to execute a subsequent processing function.

Having thus described in detail preferred embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. An electronic device, comprising:
an electronic device storage part that stores at least a license check processing program,
a license setting information; and
an application program execution part that executes an application program and determines whether or not a license authenticated.

2. The electronic device as claimed in claim 1, wherein the license check processing program determines whether a license is authenticated.

3. The electronic device as claimed in claim 1, wherein the license check processing program executes as a function of the application program.

4. The electronic device as claimed in claim 1, wherein the application program skips the processing function corresponding to the license check processing program to execute a subsequent processing function when the license is not authenticated.

5. The electronic device as claimed in claim 1, wherein the license setting information includes at least one location information where the license check processing program is executed within the application program.

6. The electronic device as claimed in claim 5, wherein the application program execution part executes the application program by associating the license check processing program with a preset location in the application program based on the licensed setting information.

7. The electronic device as claimed in claim 1, further comprising an electronic device communication part connected to a network,
wherein the license check processing program and the license setting information that are stored in the electronic device storage part are inputted via the electronic device communication part.

8. The electronic device as claimed in claim 1, wherein after a license is authenticated, the license check processing program and the license setting information are transmitted in response to a request for license authentication made from the electronic device communication part to a server which is connected to the network.

9. An application authentication method, comprising the steps of:
storing license authentication information for authenticating a license with respect to an application program,
providing a license check processing program and license setting information;
receiving a license ID;
verifying whether the license ID received is authenticated based on the license authentication information; and
transmitting the license check processing program and the license setting information when the received license ID is authenticated.

10. An application execution system comprising:
an electronic device for executing an application program;
a server connected to the electronic device via a network for performing license authentication with respect to the application program.

11. The application execution system as claimed in claim 10, whereby the electronic device further comprising:
an electronic device communication part that transmits a license ID for authenticating a license with respect to the application program to the server via a network, and receives from the server a license check processing program for checking a license and executing a processing function of the application program and license setting information,
an electronic device storage part that stores the license check processing program and the license setting information; and
an application program execution part that executes the application program.

12. The application execution system as claimed in claim 11, wherein the license ID is transmitted for licensed authentication with respect to the application program.

13. The application execution system as claimed in claim 11, wherein the license checking program is received for authenticating a license in order to execute a processing function of the application program.

14. The application execution system as claimed in claim 11, wherein the license setting information contains location information where the license check processing program is incorporated into the application program.

15. The application execution system as claimed in claim 11, whereby the server further comprising:
a server storage part that stores license authentication information,
the license check processing program, and
the license setting information;
a server communication part that receives the license ID from the electronic device via the network and transmits the license check processing program and the license setting information to the electronic device; and
a license check part that performs transmission control of the license check processing program and the license setting information that correspond to the license ID after authenticating a received license ID based on the license authentication information.

16. The application execution system as claimed in claim 10, wherein the application program execution part executes the application program by associating a license check processing program with a preset location in the application program based on the licensed setting information stored in the electronic device storage part.

17. The application execution system as claimed in claim 16, wherein the application execution part performs a license authentication check with the license check processing program associated with the preset location in the application program.

18. The application execution system as claimed in claim 17, wherein when the license is not authenticated, the application execution part skips the processing function corresponding to the license check processing program to a subsequent processing function.

19. A computer readable medium comprising executable program instructions that, when executed by a computer causes the computer of an electronic device to implement a method for executing an application program, the method comprising the steps of:
storing a license check processing program and license setting information;
executing the application program by associating the license check processing program with a preset location in the application program; and
performing a license authentication check by the license check processing program associated with the preset location.

20. The computer readable medium as claimed in claim 19, wherein the license check processing program checks a license to execute a function of the application program.

21. The computer readable medium as claimed in claim 19, wherein the license setting information contains location information where the license check processing program is incorporated into the application program.

22. The computer readable medium as claimed in claim 19, wherein the license checking program is associated with a preset location in the application program based on the licensed setting information.

23. The computer readable medium as claimed in claim 19, wherein when the license is not authenticated, the license authenticating step skips the license check processing function to execute a subsequent processing function.
